(19) United States
(12) Patent Application Publication
(10) Pub. No.: US 2011/0006569 A1
(43) Pub. Date: Jan. 13, 2011

(54) Attachment for a child's vehicle seat

(76) Inventor: Laura Davies, Wigan (GB)

Correspondence Address: JAMES C. WRAY, 1493 CHAIN BRIDGE ROAD, SUITE 300, MCLEAN, VA, 22101, US

(21) Appl. No.: 12/661,589

(22) Filed: Mar. 19, 2010

(30) Foreign Application Priority Data
Jul. 7, 2009 (GB) 09 11 720.1

(51) Int. Cl. B60N 2/58; A47C 31/00; B60N 2/26

(52) U.S. Cl. 297/217.4

(57) ABSTRACT

Apparatus for attaching to a child vehicle seat comprising: a seat cover portion for locating on a child vehicle seat; the seat cover portion defining at least two slots configured to allow a seat belt to pass therethrough. A transducer unit configured to provide mechanical vibrations; and a signal generator unit for supplying the transducer unit with an electrical signal to enable the transducer unit to mechanically vibrate.

The present invention relates to apparatus for attaching to a child's vehicle seat.

Seat covers that can be attached to a child's vehicle seat are known. A problem exists in that a child may become agitated and restless during a car journey requiring the driver or the passenger to attend to the child. This can be distracting for the driver and distressful for the child.

According to an aspect of the present invention, there is provided apparatus for attaching to a child vehicle seat comprising: a seat cover portion for locating on a child vehicle seat; said seat cover portion defining at least two slots configured to allow a seat belt to pass therethrough, a transducer configured to provide mechanical vibrations and further configured to provide sound; and a signal generator unit for supplying said transducer with an electrical signal to enable said transducer to mechanically vibrate.

The invention will now be described by way of example only, with reference to the accompanying drawings, of which:

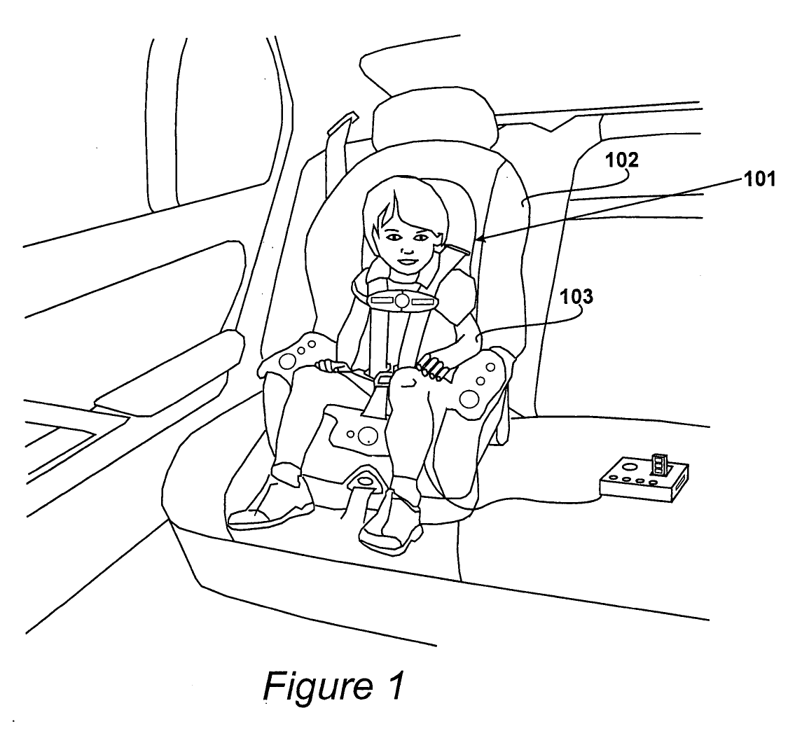

FIG. 1 shows apparatus 101 according to the present invention in use;

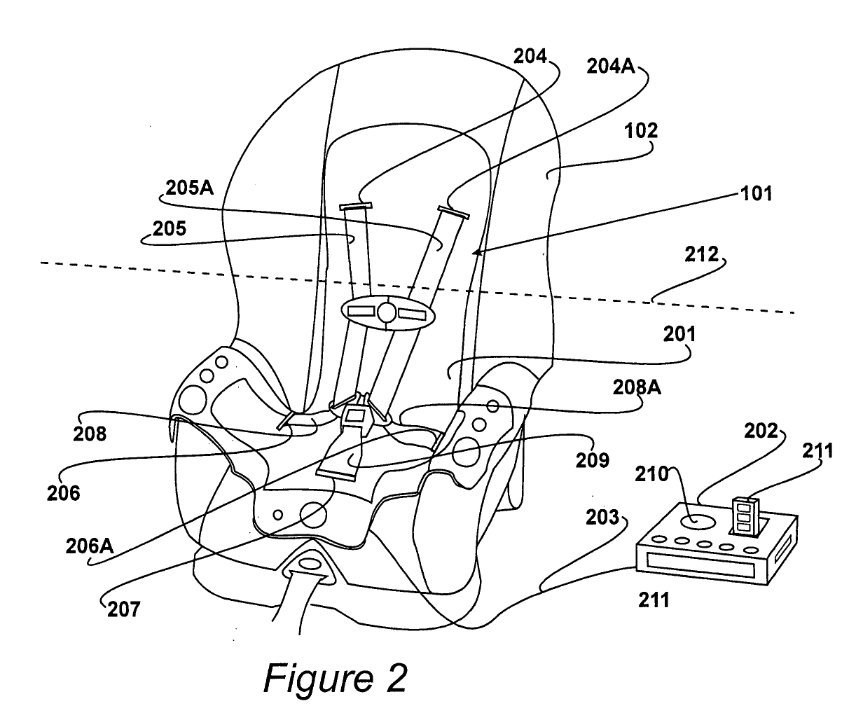

FIG. 2 shows apparatus 101 located on child vehicle seat 102;

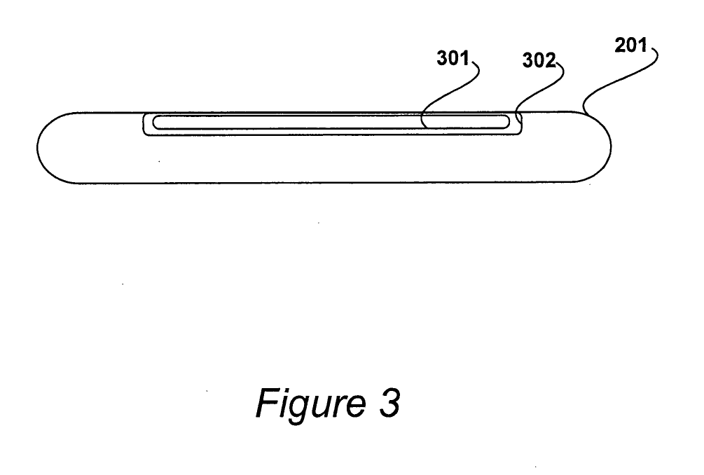

FIG. 3 shows a cross sectional view of apparatus 101, along line 212 of FIG. 2;

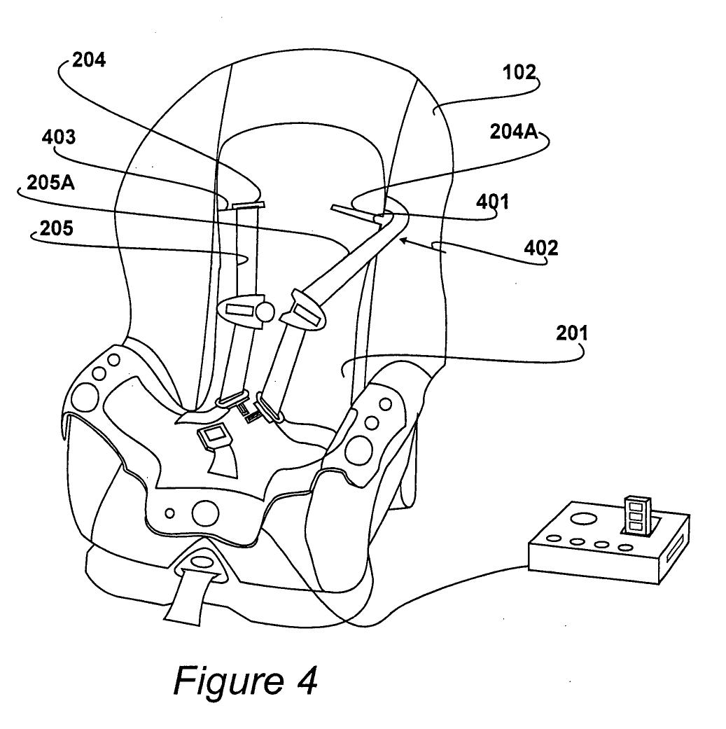

FIG. 4 shows an alternative embodiment of the present invention in which the slots, such as slot 204 and 204A, define an open edge;

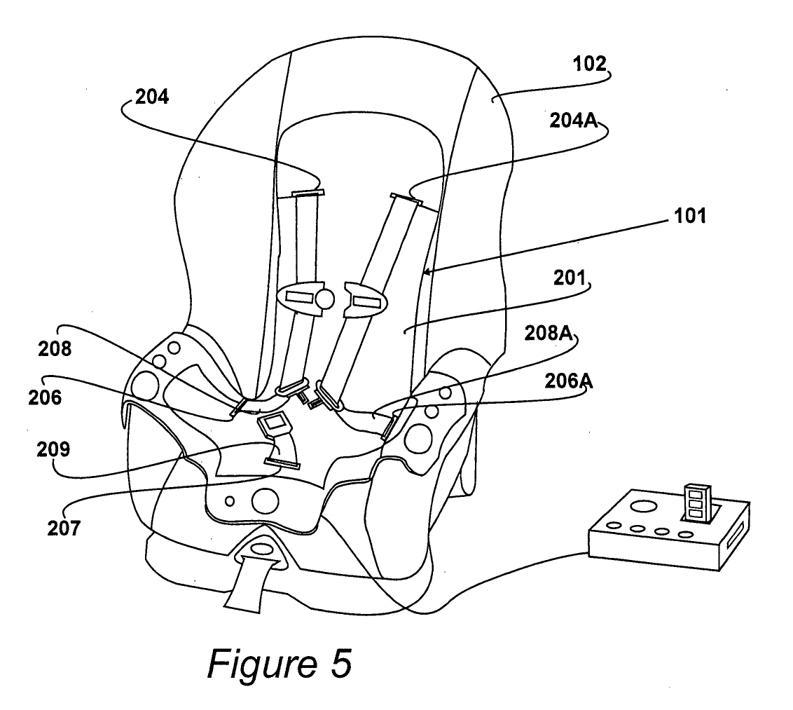

FIG. 5 shows the alternative embodiment of FIG. 4;

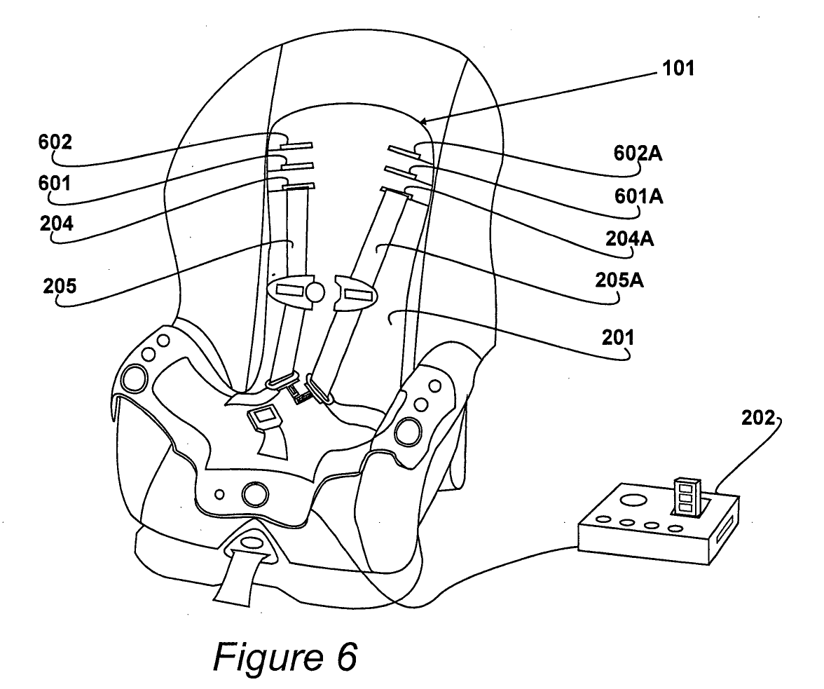

FIG. 6 shows a further alternative embodiment of the present invention;

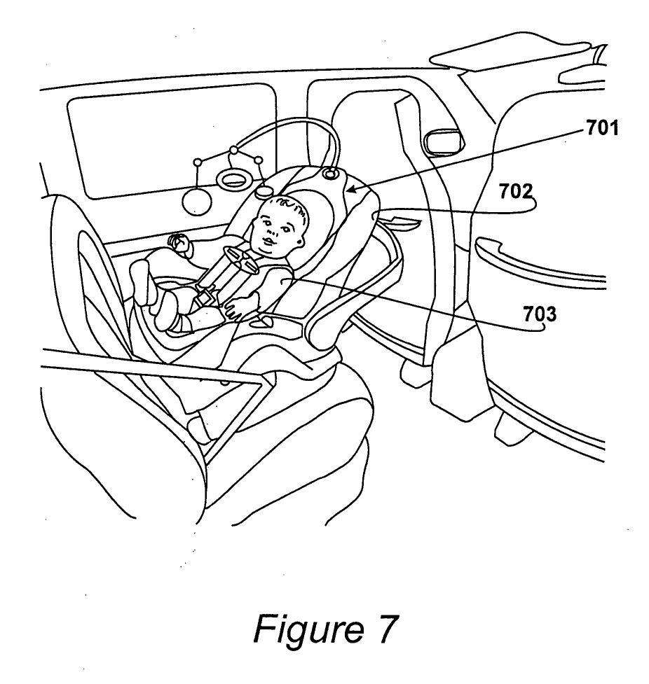

FIG. 7 shows a further alternative embodiment of the present invention; and

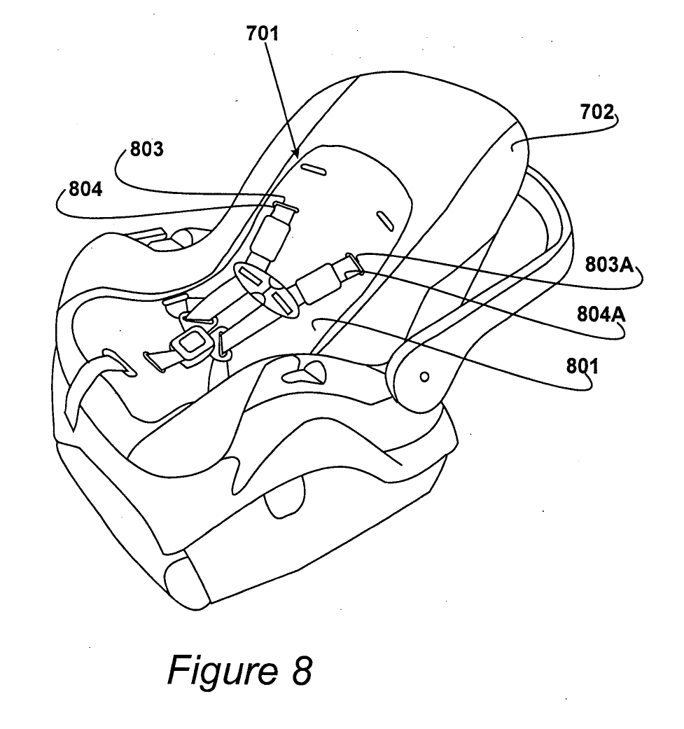

FIG. 8 shows apparatus 701 located on child vehicle seat 702.

FIG. 1

FIG. 1 shows apparatus 101 according to the present invention in use. Apparatus 101 is configured for use in a child vehicle seat, such as vehicle seat 102. Apparatus 101 is located on child vehicle seat 102 enabling a child such as child 103 to be seated upon apparatus 101 whilst using child vehicle seat 102. Apparatus 101 will now be described in further detail in FIG. 2.

FIG. 2

FIG. 2 shows apparatus 101 located on child vehicle seat 102. Apparatus 101 comprises of seat cover portion 201, a signal generator unit 202 and a transducer unit (not shown) located within seat cover portion 201. Signal generator unit 202 is connected to the transducer unit via wire 203 and supplies the transducer with an electrical signal that is configured to enable the transducer unit to mechanically vibrate. In the present embodiment the transducer unit is configured to produce vibrations that are relaxing a calming to a child when sat upon apparatus 101. In the present embodiment seat cover portion 201 comprises of a water-repellent material to allow it to be easily wiped clean or placed in the washing machine. Padded areas will also be present within seat cover portion 201 to increase the comfort of a child, for example a padded area will correspond to the area that a child would place their head and arms.

Apparatus 101 also comprises slots, such as slots 204 and 204A, located to correspond with the position of the seat belts of child vehicle seat 102. The slots are configured to allow the seat belts to pass through each slot to enable a child to be fastened safely into vehicle car seat 102. In the present embodiment apparatus 101 comprises slots 204 and 204A that are located to correspond with the position of shoulder belts 205 and 205A. Slots 206, 206A and 207 are also present and are positioned to correspond with lap belts 208, 208A and belt 209 that is positioned between a child's legs. As illustrated in FIG. 2 the slots, such as slots 204, 204A, 206, 206A and 207 define closed edges and require each seat belt to be fed through the aperture of each slot. However, it should be appreciated that in an alternative embodiment apparatus 101 only comprises slots 204 and 204A to correspond with shoulder belts 205 and 205A.

Signal generator unit 202 also houses a control unit (not shown) that is configured to control whether or not the electrical signal is supplied to the transducer unit causing the transducer unit to mechanically vibrate. The control unit will also be used to control whether or not the signal generator unit 202 receives power using a simple on/off switch, such as switch 210. It is also envisaged that a simple on/off switch will be used to control the supply of the electrical signal to the transducer unit. The rate at which the electrical signal is supplied to the transducer unit is also controlled using the control unit, therefore altering the rate at which the electrical signal is supplied to the transducer unit. This allows a user to control the rate at which the vibrations are produced, and therefore determine a rate at which a child feels most comfortable with. It is envisaged plus and minus buttons will be used to control the rate at which the electrical signal is supplied to the transducer unit. In the present embodiment signal generator unit 202 is battery powered, however in an alternative embodiment signal generator unit 202 is configured to receive power from the vehicle itself. Signal generator unit 202 maybe stored on the seat of a vehicle or in the foot well of a vehicle.

As illustrated in FIG. 2, wireless remote control 211 is docked with signal generator unit 202 to enable wireless remote control 211 to be recharged. Wireless remote control 211 is wirelessly linked to the control unit and can be used by a driver or passenger to control signal generator unit 202 and therefore to control whether or not an electrical signal is supplied to the transducer unit of apparatus 101.

FIG. 3

FIG. 3 shows a cross sectional view of apparatus 101, along line 212 of FIG. 2. As previously described apparatus 101 comprises of seat cover portion 201, a signal generator unit (not shown) and a transducer unit 301 that is located within seat cover portion 201. The signal generator unit is connected to the transducer unit 301 via a wire and supplies the transducer unit 301 with an electrical signal that is configured to enable transducer unit 301 to mechanically vibrate. In order to securely locate transducer unit 301 within seat cover portion 201 an inner pocket 302 is defined within the seat cover portion 201. Inner pocket 302 is configured to securely house transducer unit 301 within itself and therefore within seat cover portion 201. Transducer unit 301 may also be easily removed from seat cover portion 201 allowing the seat cover portion to be washed, the transducer unit may then be placed back in inner pocket 302 before use.

In the embodiment transducer unit 301 comprises piezoelectric ceramics and is encased in a waterproof material, such as a rubber compound, to protect the transducer should any spillage occur. It should be appreciated that in alternative embodiments of the present invention any appropriate transducer could be provided and any appropriate waterproof material could be used to encase the transducer unit 301.

FIG. 4

FIG. 4 shows an alternative embodiment of the present invention in which the slots, such as slot 204 and 204A, define an open edge. FIG. 4 shows how seat cover portion 201 is located upon child vehicle seat 102, without interfering with the fastening of seat belts, such as shoulder belts 205 and 205A.

As previously stated slot 204A defines an open edge 401. Open edge 401 enables a user to easily place shoulder belt 205A through open edge 401 in the direction illustrated by arrow 402. Open edge 401 of slot 204A may then be manually sealed to hold shoulder belt 205A in place. This is illustrated by slot 204 comprising a manually sealed open edge 403. In the present embodiment slots 204 and 204A comprise a Velcro® fastening allowing the slots to be manually sealed. However, in alternative embodiments other appropriate fastening mechanisms, such as a zip or buttons, are used to manually seal the open edges of slots.

FIG. 5

FIG. 5 shows the alternative embodiment of FIG. 4. In the present embodiment apparatus 101 comprises slots 206, 206A and 207, in addition to slots 204 and 204A. Each of slots 204, 204A, 206, 206A and 207 comprise manually sealable open edges to allow shoulder belts 205, 205A, lap belts 208, 208A and belt 209 to easily pass therethough.

Slots that comprise manually sealable open edges allow seat cover portion 201 to be quickly and easily located and removed from child vehicle seat 102, whilst at the same time not interfering with seat belt safety.

FIG. 6

FIG. 6 shows a further alternative embodiment of the present invention. In the present embodiment apparatus 101 further comprises slots 601, 601A, 602 and 602A in addition to slots 204 and 204A. Slots 601, 601A, 602 and 602A are evenly spaced above slots 204 and 204A and allow a user to alter the height of shoulder belts 205 and 205A depending upon the height of the child and the position of shoulder belts 205 and 205A in relation to seat cover portion 201.

According to the present embodiment the transducer unit (not shown) housed within seat cover portion 201 is further configured to produce sound as well as vibrations. This function enables a user to play music to the child in conjunction with the vibrations, or alone. As previously described with reference to FIG. 2, signal generator unit 202 also houses a control unit (not shown) that is configured to control whether or not the electrical signal is supplied to the transducer unit causing the transducer unit to mechanically vibrate. In the present embodiment the control unit will also control the production of sound and/or vibrations by the transducer unit. It is also envisaged that signal generator unit 202 will further comprise MP3 capability allowing music to be played from the MP3 player.

In the present embodiment the control unit further comprises a timer that is configured to determine the duration that the electrical signal is supplied from the signal generator unit 202 to the transducer unit.

FIG. 7

FIG. 7 shows a further alternative embodiment of the present invention. Apparatus 701 is configured for use in a new born vehicle seat, such as vehicle seat 702. Apparatus 701 is located on new born vehicle seat 702 enabling a infant such as infant 703 to be seated upon apparatus 701 whilst using vehicle seat 702. Apparatus 701 will now be described in further detail in FIG. 8.

FIG. 8

FIG. 8 shows apparatus 701 located on child vehicle seat 702. Apparatus 701 comprises of seat cover portion 801, a signal generator unit (not shown) and a transducer unit (not shown) located within seat cover portion 801. The signal generator unit is connected to the transducer unit via a wire and supplies the transducer unit with an electrical signal that is configured to enable the transducer unit to mechanically vibrate. In the present embodiment the transducer unit is configured to produce vibrations that are relaxing a calming to a child when sat upon apparatus 701. In the present embodiment seat cover portion 801 comprises of a water-repellent material to allow it to be easily wiped clean or placed in the washing machine. Padded areas will also be present within seat cover portion 801 to increase the comfort of an infant, for example a padded area will correspond to the area that a infant would place there head and arms.

Apparatus 701 also comprises slots, such as slots 803 and 803A, located to correspond with the position of the seat belts of child vehicle seat 702. The slots are configured to allow the seat belts to pass through each slot to enable an infant to be fastened safely into vehicle car seat 702. In the present embodiment apparatus 701 comprises slots 803 and 803A that are located to correspond with the position of shoulder belts 804 and 804A.

1. Apparatus for attaching to a child vehicle seat comprising:
a seat cover portion for locating on a child vehicle seat;
said seat cover portion defining at least two slots configured to allow a seat belt to pass therethrough,
a transducer unit configured to provide mechanical vibrations and further configured to provide sound; and
a signal generator unit for supplying said transducer unit with an electrical signal to enable said transducer unit to mechanically vibrate.

2. An apparatus according to claim 1, wherein said seat cover portion further defines inner pocket configured to house said transducer unit.

3. An apparatus according to claim 1, wherein said at least two slots define an open edge.

4. An apparatus according to claim 1, wherein said open edge is configured to be manually sealed.

5. An apparatus according to claim 4, wherein said open edge is manually sealed.

6. An apparatus according to claim 1, wherein said at least two slots define closed edges.

7. An apparatus according to claim 1, wherein said transducer unit comprises piezoelectric ceramics.

8. An apparatus according to claim 1, wherein said transducer unit is encased in a waterproof material.

9. An apparatus according to claim 1, wherein said signal generator unit further comprises a control unit configured to control said electrical signal supplied to said transducer unit.

10. An apparatus according to claim 1, wherein said signal generator unit is configured to receive power from a vehicle.

11. An apparatus according to claim 1, wherein said signal generator is battery powered.

12. An apparatus according to claim 9, wherein said control unit further comprises a timer configured to determine the duration that the electrical signal supplied by said signal generator unit.

13. The apparatus according to claim 9, further comprising a wireless remote control unit.

14. The apparatus according to claim 13, wherein said wireless remote control unit is configured to be docked with the signal generator unit to enable recharging.

15. An apparatus according to claim 1, wherein said seat cover portion comprises of a water-repellent material.

16. An apparatus according to claim 1, wherein said seat cover portion comprises at least one padded area.

17. A child vehicle seat in combination with the apparatus according to claim 1.

18. (canceled)

19. (canceled)
